(19) United States
(12) Patent Application Publication
(10) Pub. No.: US 2023/0350259 A1
(43) Pub. Date: Nov. 2, 2023

(54) METHOD AND APPARATUS FOR ELECTROCHROMIC GLASS CAMERA SHUTTER

(71) Applicant: Dell Products, LP, Round Rock, TX (US)

(72) Inventors: Hong Ling Chen, Taoyuan City (TW); Hou Chun Wang, Linkou District (TW); En-Yu Jen, New Taipei City (TW); Chen-Yu Lin, Songshan District (TW); Lee-Ching Kuo, Taipei (TW); Shao Che Huang, Shilin District (TW)

(73) Assignee: Dell Products, LP, Round Rock, TX (US)

(21) Appl. No.: 17/733,965

(22) Filed: Apr. 29, 2022

(51) Int. Cl. G02F 1/163; G02F 1/155; G06F 21/83

(52) U.S. Cl. CPC G02F 1/163; G02F 1/155; G06F 21/83

(57) ABSTRACT

An information handling system may include a processor, a memory device, a power management unit (PMU), and a camera formed into a chassis of the information handling system. The camera may include a lens and an electronic image capture component, and an electrochromic glass shutter formed over the lens, the electrochromic glass shutter operatively coupled to a circuit switch to receive a voltage to change the opacity of the electrochromic glass shutter, the circuit switch operatively coupled to and controlled by an embedded controller.

### FIELD OF THE DISCLOSURE

The present disclosure generally relates to a camera formed into a chassis of an information handling system. The present disclosure more specifically relates to a privacy shutter of a camera formed into a chassis of an information handling system.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling needs and requirements vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. Further, the information handling system may include a camera used to capture images of a user, engage in a videoconference, among other tasks.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system with camera module according to an embodiment of the present disclosure;

FIG. 2 is a graphic diagram of a camera module with a frame and electrochromic glass layer over the camera according to an embodiment of the present disclosure;

FIG. 3 is a graphic diagram of an electrochromic glass layer changing from translucent to opaque in an embodiment of the present disclosure;

FIG. 4 is a graphic diagram of an electrochromic glass layer to be formed over a camera according to an embodiment of the present disclosure;

FIG. 5 is a block diagram of an embedded controller camera control circuit according to an embodiment of the present disclosure; and

FIG. 6 is a flow diagram of a method of manufacturing an information handling system with a camera and an electrochromic glass layer formed over the camera according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Information handling systems allow a user to communicate with others that are remoted from the user. Engaging in video conferencing sessions is one of these forms of communication. Although a camera installed in the chassis of the information handling system may be used for other purposes, the camera or webcam is more popularly used to, in real-time, engage in these video conferences. The user, via the camera and execution by a processor of a video conferencing application, may talk to another person remote from the user while seeing the remote person and providing video images of the user to that remote person as well. Often, the video conferencing applications give the user the ability to turn off the video feed of their camera so that others on the video conferencing sessions can no longer see the user. However, due to potential security breaches in the operating system (OS) or basic input/output system (BIOS) by others, an e-shutter may be implemented for privacy purposes in order to prevent the user from being seen. This e-shutter may include a physical shutter that may be placed over the camera when the user does not want to be seen and may be activated by the user's action, by software implementation, or a combination thereof. Some of these e-shutters, however, may fail due to the mechanical parts used to move the physical shutter in front of the camera. Indeed, a relatively high precision in the moving parts associated with the e-shutter is necessary and without that precision, the e-shutter may become dislodged, open at an intermediary point, close at an intermediary point, or not open or close at all. This issue becomes especially problematic if the information handling system is bumped or dropped. Further, the manufacture of such a precision e-shutter can be expensive due to the tolerances needed as well as the precision assembly of the e-shutter system among other factors.

The present specification describes an electrochromic glass layer as part of an electrochromic glass shutter used in place of a mechanical e-shutter. The electrochromic glass shutter may be turned translucent or opaque based on the voltage applied to the electrochromic glass layer in the electrochromic shutter. This allows a user to not only physically see that the camera's view has been blocked and therefore the camera's image capture is blocked, but also overcomes the issues of using mechanical parts to block the view of the camera. In an embodiment of the present specification, an information handling system may include a processor, a memory device, and a power management unit (PMU). A camera, such as a webcam, may be operatively coupled to the processor and PMU to control the capture and transmission of images of the user as the user sits in front of the camera. The camera, in an embodiment, is formed into a chassis of the information handling system at, for example, a top portion of a bezel so that the camera may be facing the user and useful as a webcam. The camera includes a lens and an electrochromic glass shutter over the lens. The electrochromic glass shutter is operatively coupled to the PMU to receive a voltage via a circuit switch used to change the opacity of the electrochromic glass layer in the electrochromic glass shutter in an example embodiment. The electrochromic glass shutter may also be operatively coupled to and controlled by an embedded controller (EC) which may control the voltage from the PMU. The embedded controller, in an example embodiment, may be separate from the processor and may execute computer code below the OS and BIOS in order to prevent the opacity of the electrochromic glass shutter being changed by a others users engaged in breaching the security of the OS or BIOS. Further, the EC may execute code instructions to change the opacity of the electrochromic glass shutter so that the processor of the information handling system may provide processing resources to other tasks being executed on the information handling system.

A dedicated button or “hot-key” may be used by the user to cause the EC to change the opacity of the electrochromic glass shutter in one embodiment. In another embodiment, a soft key or software controller for settings may be used. As such, the user may be in complete control of the opacity or translucency of the electrochromic glass layer if and when the camera transmits an image of the user. This further avoids the potential damages in mechanical-based e-shutters because the camera and electrochromic glass shutter do not have moving parts.

In an embodiment, the electrochromic glass shutter may be placed on a frame. The frame may be affixed to a printed circuit board (PCB) over the camera module and lens so that the electrochromic glass shutter may be placed thereon. In another embodiment, the electrochromic glass shutter may be placed into a window formed in a bezel of the information handling system over a location where the camera will be placed within the chassis of the information handling system.

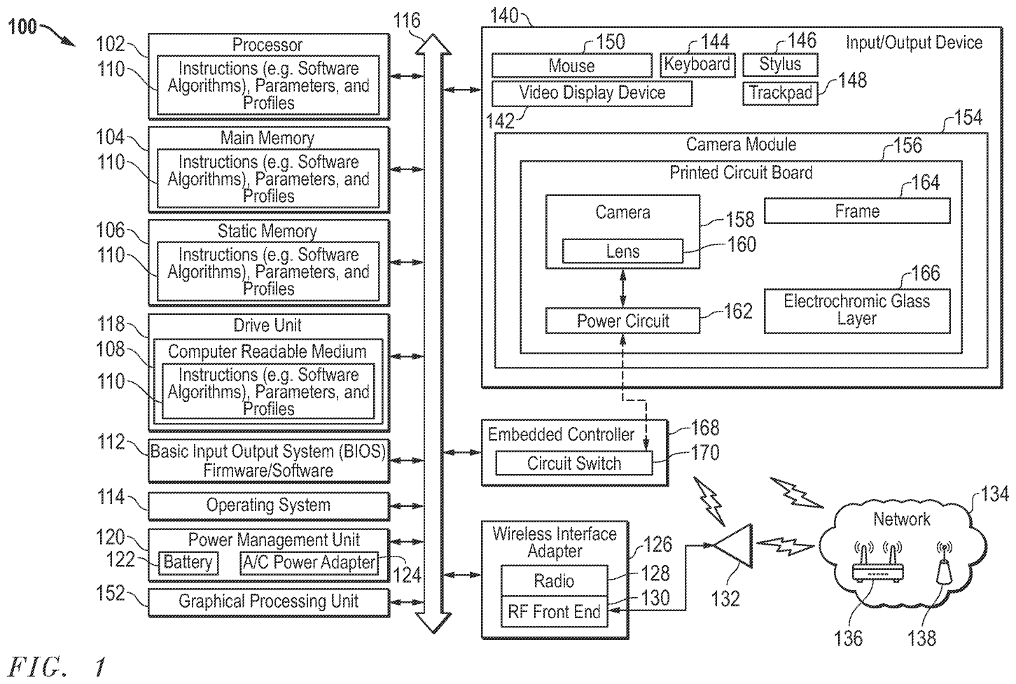

FIG. 1 illustrates an information handling system 100 similar to information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a convertible laptop, a tablet, a smartphone, a communications device, an access point (AP), a base station transceiver, a wireless telephone, a control system, a camera, a scanner, a printer, a personal trusted device, a web appliance, or any other suitable machine capable of executing a set of instructions (sequential or otherwise) that specify actions to be taken by that machine, and can vary in size, shape, performance, price, and functionality.

In a networked deployment, the information handling system 100 may operate in the capacity of a server or as a client computer in a server-client network environment, or as a peer computer system in a peer-to-peer (or distributed) network environment. In a particular embodiment, the computer system 100 can be implemented using electronic devices that provide voice, video, or data communication. For example, an information handling system 100 may be any mobile or other computing device capable of executing a set of instructions (sequential or otherwise) that specify actions to be taken by that machine. In an embodiment, the information handling system 100 may be operatively coupled to a server or other network device allowing for, in some embodiments, the user to communicate with other people via execution of a videoconference application on the information handling system 100. Further, while a single information handling system 100 is illustrated, the term “system” shall also be taken to include any collection of systems or sub-systems that individually or jointly execute a set, or multiple sets, of instructions to perform one or more computer functions.

The information handling system 100 may include memory (volatile (e.g., random-access memory, etc.), nonvolatile (read-only memory, flash memory etc.) or any combination thereof), one or more processing resources, such as a central processing unit (CPU), a graphics processing unit (GPU) 152, processing, hardware, controller, or any combination thereof. Additional components of the information handling system 100 can include one or more storage devices, one or more communications ports for communicating with external devices, as well as, various input and output (I/O) devices 140, such as a keyboard 144, a mouse 150, a video display device 142, a stylus 146, a trackpad 148, and an XR handheld controller, or any combination thereof. The information handling system 100 can also include one or more buses 116 operable to transmit data communications between the various hardware components described herein. Portions of an information handling system 100 may themselves be considered information handling systems and some or all of which may be wireless.

Information handling system 100 can include devices or modules that embody one or more of the devices or execute instructions for the one or more systems and modules described above, and operates to perform one or more of the methods described above. The information handling system 100 may execute code instructions 110 via processing resources that may operate on servers or systems, remote data centers, or on-box in individual client information handling systems according to various embodiments herein. In some embodiments, it is understood any or all portions of code instructions 110 may operate on a plurality of information handling systems 100.

The information handling system 100 may include processing resources such as a processor 102 such as a central processing unit (CPU), accelerated processing unit (APU), a neural processing unit (NPU), a vision processing unit (VPU), an embedded controller (EC), a digital signal processor (DSP), a GPU 152, a microcontroller, or any other type of processing device that executes code instructions to perform the processes described herein. Any of the processing resources may operate to execute code that is either firmware or software code. Moreover, the information handling system 100 can include memory such as main memory 104, static memory 106, computer readable medium 108 storing instructions 110 of, in an example embodiment, a video conferencing application, an image capturing application, or other computer executable program code, and drive unit 118 (volatile (e.g., random-access memory, etc.), nonvolatile (read-only memory, flash memory etc.) or any combination thereof).

As shown, the information handling system 100 may further include a video display device 142. The video display device 142, in an embodiment, may function as a liquid crystal display (LCD), an organic light emitting diode (OLED), a flat panel display, or a solid-state display. Although FIG. 1 shows a single video display device 142, the present specification contemplates that multiple video display devices 142 may be used with the information handling system to facilitate an extended desktop scenario, for example. Additionally, the information handling system 100 may include one or more input/output devices 140 including an alpha numeric input device such as a keyboard 144 and/or a cursor control device, such as a mouse 150, touchpad/trackpad 148, a stylus 146, or a gesture or touch screen input device associated with the video display device 142 that allow a user to interact with the images, windows, and applications presented to the user. In an embodiment, the video display device 142 may provide output to a user that includes, for example, one or more windows describing one or more instances of applications being executed by the processor 102 of the information handling system. In this example embodiment, a window may be presented to the user that provides a GUI representing the execution of that application.

The network interface device of the information handling system 100 shown as wireless interface adapter 126 can provide connectivity among devices such as with Bluetooth or to a network 134, e.g., a wide area network (WAN), a local area network (LAN), wireless local area network (WLAN), a wireless personal area network (WPAN), a wireless wide area network (WWAN), or other network. In an embodiment, the WAN, WWAN, LAN, and WLAN may each include an access point 136 or base station 138 used to operatively couple the information handling system 100 to a network 134. In a specific embodiment, the network 134 may include macro-cellular connections via one or more base stations 138 or a wireless access point 136 (e.g., Wi-Fi or WiGig), or such as through licensed or unlicensed WWAN small cell base stations 138. Connectivity may be via wired or wireless connection. For example, wireless network access points 136 or base stations 138 may be operatively connected to the information handling system 100. Wireless interface adapter 126 may include one or more radio frequency (RF) subsystems (e.g., radio 128) with transmitter/receiver circuitry, modem circuitry, one or more antenna front end circuits 130, one or more wireless controller circuits, amplifiers, antennas 132 and other circuitry of the radio 128 such as one or more antenna ports used for wireless communications via multiple radio access technologies (RATs). The radio 128 may communicate with one or more wireless technology protocols. In and embodiment, the radio 128 may contain individual subscriber identity module (SIM) profiles for each technology service provider and their available protocols for any operating subscriber-based radio access technologies such as cellular LTE communications.

In an example embodiment, the wireless interface adapter 126, radio 128, and antenna 132 may provide connectivity to one or more of the peripheral devices that may include a wireless video display device 142, a wireless keyboard 144, a wireless mouse 150, a wireless headset, a microphone, an audio headset, a wireless stylus 146, and a wireless trackpad 148, among other wireless peripheral devices used as input/output (I/O) devices 140.

As described, the wireless interface adapter 126 and the HMD wireless radio may include any number of antennas 132 in various embodiments. Further, these antennas 132 may include any number of tunable antennas for use with the system and methods disclosed herein in some embodiments. Although FIG. 1 shows a single antenna 132, the present specification contemplates that the number of antennas 132 may include more or less of the number of individual antennas shown in FIG. 1. Additional antenna system modification circuitry (not shown) may also be included with the wireless interface adapter 126 to implement coexistence control measures via an antenna controller in various embodiments of the present disclosure.

In some aspects of the present disclosure, the wireless interface adapter 126 may operate two or more wireless links. In an embodiment, the wireless interface adapter 126 may operate a Bluetooth wireless link using a Bluetooth wireless or Bluetooth extended protocols. In an embodiment, the Bluetooth wireless protocol may operate at frequencies between 2.402 to 2.48 GHz. Other Bluetooth operating frequencies such as Bluetooth extended frequencies at 6 GHz are also contemplated in the presented description. In an embodiment, a Bluetooth wireless link may be used to wirelessly couple the input/output devices operatively and wirelessly including the mouse 150, keyboard 144, stylus 146, trackpad 148, and/or video display device 142 to the bus 116 in order for these devices to operate wirelessly with the information handling system 100. In a further aspect, the wireless interface adapter 126 may operate the two or more wireless links with a single, shared communication frequency band such as with the 5G standard relating to unlicensed wireless spectrum for small cell 5G operation or for unlicensed Wi-Fi WLAN operation in an example aspect. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas 132 may be capable of operating at a variety of frequency bands. In a specific embodiment described herein, the shared, wireless communication band may be transmitted through a plurality of antennas used to operate in an N×N MIMO array configuration where multiple antennas 132 are used to exploit multipath propagation which may be any variable N. For example, N may equal 2, 3, or 4 to be 2×2, 3×3, or 4×4 MIMO operation in some embodiments. Other communication frequency bands, channels, and transception arrangements are contemplated for use with the embodiments of the present disclosure as well and the present specification contemplates the use of a variety of communication frequency bands.

The wireless interface adapter 126 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth standards, or similar wireless standards may be used. Wireless interface adapter 126 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the −5 MHz frequency band such as 802.11 a/h/j/n/ac/ax (e.g., center frequencies between 5.170-7.125 GHz). WLAN, for example, may operate at a 2.4 GHz band, 5 GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 1 (NRFR1), NFRF2, bands, and other known bands. Each of these frequencies used to communicate over the network 134 may be based on the radio access network (RAN) standards that implement, for example, eNodeB or gNodeB hardware connected to mobile phone networks (e.g., cellular networks) used to communicate with the information handling system 100. In the example embodiment, the information handling system 100 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end (e.g., antenna front end 130 circuits) of the information handling system 100 may operate on a licensed WWAN wireless radio with authorization for subscriber access to a wireless service provider on a carrier licensed frequency band.

In other aspects, the information handling system 100 operating as a mobile information handling system may operate a plurality of wireless interface adapters 126 for concurrent radio operation in one or more wireless communication bands. The plurality of wireless interface adapters 126 may further share a wireless communication band or operate in nearby wireless communication bands in some embodiments. Further, harmonics and other effects may impact wireless link operation when a plurality of wireless links are operating concurrently as in some of the presently described embodiments.

The wireless interface adapter 126 can represent an add-in card, wireless network interface module that is integrated with a main board of the information handling system 100 or integrated with another wireless network interface capability, or any combination thereof. In an embodiment the wireless interface adapter 126 may include one or more radio frequency subsystems including transmitters and wireless controllers for connecting via a multitude of wireless links. In an example embodiment, an information handling system 100 may have an antenna system transmitter for Bluetooth, Bluetooth Extended, 5G small cell WWAN, or Wi-Fi WLAN, Wi-Fi 6e connectivity and one or more additional antenna system transmitters for macro-cellular communication. The RF subsystems and radios 128 and include wireless controllers to manage authentication, connectivity, communications, power levels for transmission, buffering, error correction, baseband processing, and other functions of the wireless interface adapter 126.

In an embodiment, the information handling system 100 may include a camera module 154 with a camera 158 such as a webcam. In an embodiment, the camera 158 may be an input/output device 140 that captures images of the user and the surrounding area. As described herein, the camera 158 may be used during the execution of a videoconferencing application. Although the present specification contemplates that the camera 158 may be used for other purposes, the present specification describes the use of the camera 158 in connection with a videoconferencing session. The camera 158 may form part of a camera module 154 that may be placed within a display chassis of the information handling system 100. In the context of the present specification, the information handling system may be any type of information handling system that includes a display chassis such as a 360-degree laptop type information handling system. In these embodiments, the chassis of the information handling system may include a display housing that includes an “a-cover” which serves as a back cover for the display housing and a “b-cover” which may serve as the bezel for a display screen of the information handling system such as a laptop information handling system. In this example embodiment, the laptop information handling system may have a chassis that forms a base housing and includes a “c-cover” or top cover housing a keyboard, touchpad, and any cover in which these components are set and a “d-cover” or bottom cover of the base chassis housing a processing device, memory, the PMU, power systems (e.g., battery 122 or alternating current (A/C) adapter 124) wireless interface adapter and other components of the information handling system 100 in the base housing for the laptop-type information handling system 100. In an embodiment, the b-cover may include a portion of a video display device 142 and the present specification contemplates that the camera 158 may be placed behind either a bezel of the b-cover (when present) or behind the video display device 142 when a bezel is not present. In either example embodiment, a hole may be formed through the bezel or the video display device 142 so that the camera 158 can capture an image of the environment in front of the information handling system 100 including the user.

The camera module 154 includes a printed circuit board (PCB) 156 that operatively couples the components formed on the PCB 156 to each other as well as to a processor 102, a PMU 120, or a data storage device housed in, for example, the base chassis of the information handling system 100. The camera 158 may be operatively coupled to a cable connection, for example, in order to operatively couple the camera and the other components of the camera module 154 to the processor 102 or embedded controller (EC) 168 via a ribbon cable or other wired connection. The camera 158 may be any type of camera used to capture, in some embodiments, an image of the user while the user is engaged in, for example, a videoconferencing session with a remote user. A lens 160 may be included with the camera 158 to properly focus the image in the frame of the camera 158 and change that focus in some embodiments.

The camera module 154 may further include a power circuit 162 operatively coupled to the camera 158 and other components of the camera module 154 and, in an embodiment, to the PMU 120 and EC 168 of the information handling system 100. In an embodiment, the power circuit 162 may operate independent of the PMU 120 described herein. In another embodiment, the power circuit 162 may form part of or include the PMU 120. In an embodiment, the power circuit 162 is not formed on the camera module 154 and, instead, is in the base chassis of the information handling system 100.

In an embodiment, the camera module 154 may include a frame 164. The frame 164 may be made of plastic, metal, or other suitable material and may be arranged above the camera 158. In an embodiment, the frame 164 may support or hold the electrochromic glass shutter 166 in place over the camera 158 thereby placing the electrochromic glass shutter 166 at a distance away from the camera 158. The frame 164 may be secured to the PCB over the camera 158 using any type of fastening device or an adhesive, for example. The height of the frame 164 may depend on the height of the camera 158 and the distance that the electrochromic glass shutter 166 is to be placed away from the lens 160 of the camera 158. In an embodiment, the frame 164 height may be such to place the electrochromic glass shutter 166 against the lens 160 of the camera 158 to ensure blockage of image capture by the camera 158 when it is made opaque. In an embodiment, the camera 158 of the camera module 154 may be placed behind a hole, port, or window formed in a bezel or video display device 142 so that the camera 158 may capture images of the user in front of the information handling system.

In another embodiment, the electrochromic glass shutter 166 may be placed within a hole, window, or port formed in a bezel or a video display device 142. In this embodiment, the shape, thickness, and size of the electrochromic glass shutter 166 may be such that the electrochromic glass shutter 166 creates an interference fit within the window or port formed in the bezel or the video display device 142. The electrochromic glass shutter 166 may, in example embodiments, be made to look like a continuous piece of the bezel or video display device 142. Further, in some embodiments, the electrochromic glass shutter 166 may be operatively coupled to the power circuit so that a voltage may be applied across an electrochromic layer of the electrochromic glass shutter 166 as described herein.

In an embodiment, the electrochromic glass shutter 166 may include, among other layers, an electrochromic glass layer that, when a voltage is applied to the electrochromic glass layer, the opacity or transparency of the electrochromic glass layer and the electrochromic glass shutter 166 is changed. For example, an electrochromic layer of the electrochromic glass shutter 166 may include a material coating that includes lithium ions, for example, that migrate back and forth between opposing electrode layers on the electrochromic glass shutter 166. This migration to of lithium ions (e.g., from LiCoO₂ coating) to an electrode layer may cause the lithium ions to bond with, for example, a WO₃ layer causing them to reflect light. It is appreciated that the LiCoO₂ coating and WO₃ layer are merely examples and other compounds that provide for the migration of these ions may be used in embodiments herein. In other example embodiments, an electrochromic material such as an electrochromic dye may be used that changes color when a current passes through it. In yet other example embodiments, the electrochromic layer of the electrochromic glass shutter 166 may include nanocrystals that, when a voltage is created across them, change color.

In some embodiments, the camera module 154 may or may not include the frame 164. Where the frame 164 is included, the frame 164 may prevent the bezel or video display device 142 from being bent onto the lens 160 of the camera 158. In some embodiments, the frame 164 may physically abut the electrochromic glass shutter 166 acting as a support structure against the electrochromic glass shutter 166.

In an embodiment, the electrochromic glass layer and/or other layers of the electrochromic glass shutter 166 is operatively coupled to the power circuit 162 to receive a voltage in order to change the opacity or opacity level of the electrochromic glass shutter 166. This change in the opacity or opacity level of the electrochromic glass shutter 166 via application of a voltage may be true for a number of example types of electrochromic glass such as electrochromic-, suspended-particle-, micro-blind-, and polymer-dispersed liquid-crystal-based glasses. In an embodiment, the power circuit 162 may provide a level of voltage sufficient to change the opacity level or transparency level of the electrochromic glass shutter 166. For example, the power circuit 162 may provide a first voltage level at the electrochromic layer of the electrochromic glass shutter 166 may cause the electrochromic glass shutter 166 to turn opaque/nearly opaque or transparent/nearly transparent. Additionally, for example, the power circuit 162 may provide a second voltage level at the electrochromic layer of the electrochromic glass shutter 166 may cause the electrochromic glass shutter 166 to turn opaque/nearly opaque or transparent/nearly transparent.

By way of example, the power circuit 162 may provide +1.2 volt or other first voltage of electrical charge across the electrochromic layer of the electrochromic glass shutter 166 to cause the electrochromic glass shutter 166 to switch to an “on” state by, for example turning opaque and blocking image capture. In an embodiment, a single electrical pulse at +1.2 volts or other first voltage may be sufficient to establish the opacity of the electrochromic glass shutter 166 without maintaining a charge across the electrochromic layer of the electrochromic glass shutter 166. This may reduce the amount of power used to change the opacity or translucency of the electrochromic glass shutter 166 by not requiring a constant electrical current to maintain a transparent or opaque state at the electrochromic glass shutter 166. It is appreciated that any first voltage may be applied across the electrochromic layer of the electrochromic glass shutter 166 to turn the electrochromic layer of the electrochromic glass shutter 166 to an “on” state that either turns the electrochromic glass shutter 166 opaque or nearly opaque.

It is appreciated that another or second voltage (e.g., negative 1.2-volts of electrical charge across the electrochromic layer of the electrochromic glass shutter 166) may be applied to place the electrochromic glass shutter 166 into an “off” state, for example, transparent or semi-transparent. The transparent or semitransparent state allows image capture by the camera 158. In an alternative embodiment, an “off” voltage or grounding voltage level may be applied or switched across the electrochromic layer of the electrochromic glass shutter 166 to make the electrochromic glass shutter 166 transparent or semi-transparent such that any second voltage (or ground) other than the “on” pulse may change the transparency in various embodiments.

In other embodiments, it is also appreciated that any negative electrical pulse at any first voltage may be used to make the electrochromic glass shutter 166 opaque while a second voltage that is a positive voltage, or 0-volt (e.g., grounding the electrochromic layer of the electrochromic glass shutter 166), or other voltage electrical pulse may make the electrochromic glass shutter 166 transparent or semitransparent. Indeed, in some embodiments, any first voltage may turn the electrochromic glass shutter “on” and a different, second voltage may turn the electrochromic glass shutter “off” in various embodiments. For example, either or both the first voltage and second voltage may be positive or may be negative or either the first voltage and second voltage may be a switch to ground at the electrochromic glass shutter in embodiments of the present disclosure.

In another embodiment, the electrochromic glass shutter 166 may include a polymer-dispersed liquid-crystal glass layer. In this embodiment, the application of a constant electrical current at a voltage to render the electrochromic glass shutter 166 transparent. By disconnecting the electrical current from the electrochromic glass shutter 166, the electrochromic glass shutter 166 may then be rendered opaque or nearly opaque. This type of electrochromic glass shutter 166 may allow incremental degrees of light transmission through the electrochromic glass shutter 166 as well as serve as a type of security switch that renders the electrochromic glass shutter 166 opaque when power is removed from the electrochromic glass shutter 166 during, for example, a power outage so that upon a reboot of the information handling system 100, the electrochromic glass shutter 166 is opaque. This protects the user's privacy during such a situation. It is appreciated that the electrochromic glass shutter 166 may be made of any number of layers used to change the transparency or opacity of the electrochromic glass shutter 166.

In an embodiment, the camera module 154 may be operatively coupled to an EC 168 that executes a circuit switch 170 used to direct the power circuit 162 to apply an electrical charge to the electrochromic glass shutter 166 on the camera module 154. Circuit switch 170 may be operatively coupled to the power circuit 162 of the camera module 154 according to embodiments described herein. The EC 168, in an example embodiment, may operate below the OS 114 and BIOS 112. By operating below the OS 114 and BIOS 112, the EC 168 may operate independent of other processors such as the processor 102 and the GPU 152. This prevents the EC 168 from being accessed via a security breach. Further, this prevents the operation of the camera module 154 and electrochromic glass shutter 166 to be handled by the processor 102 thereby preventing valuable processing resources from being consumed in changing the opacity or transparency levels of the electrochromic glass shutter 166.

In an embodiment, the EC 168 may include or be operatively coupled to the circuit switch 170. The circuit switch 170 may be any type of switch that controls the power circuit 162 by receiving input to change the opacity or translucency of the electrochromic glass shutter 166 and directing the power circuit 162 to provide an electrical signal at a voltage to the electrochromic glass shutter 166 executing a switch between opaque and translucent or visa-versa. In an embodiment, the EC 168 may execute the circuit switch 170 to cause the electrical signal or voltage to be sent to the electrochromic glass shutter 166 accordingly. In an embodiment, the circuit switch 170 may be a TI switch TS3A24159 manufactured by Texas Instruments®. The present specification contemplates that any type of switch or similar switch may be used to control the power circuit 162 on the camera module 154.

In an embodiment, the EC 168 may receive input via a hot-key or other key on the keyboard 144 of the information handling system 100. For example, a user may actuate a key or series of keys on the keyboard 144 as input to the EC 168 to access the circuit switch 170 as described herein. In an embodiment, the key may be a function key such as an F9 key. In another embodiment, the user may access a settings menu in a graphical user interface (GUI) or a soft key to cause the signal to be sent to the EC 168 to conduct the change in opacity or transparency at the electrochromic glass shutter 166.

The information handling system 100 can include one or more set of instructions 110 that can be executed to cause the computer system to perform any one or more of the methods or computer-based functions disclosed herein. For example, instructions 110 may execute various software applications, software agents, or other aspects or components. Various software modules comprising application instructions 110 may be coordinated by an operating system (OS) 114, and/or via an application programming interface (API). An example OS 114 may include Windows®, Android®, and other OS types known in the art. Example APIs may include Win 32, Core Java API, or Android APIs.

The disk drive unit 118 and may include a computer-readable medium 108 in which one or more sets of instructions 110 such as software can be embedded to be executed by the processor 102 or other processing devices such as a GPU 152 to perform the processes described herein. Similarly, main memory 104 and static memory 106 may also contain a computer-readable medium for storage of one or more sets of instructions, parameters, or profiles 110 described herein. The disk drive unit 118 or static memory 106 also contain space for data storage. Further, the instructions 110 may embody one or more of the methods as described herein. In a particular embodiment, the instructions, parameters, and profiles 110 may reside completely, or at least partially, within the main memory 104, the static memory 106, and/or within the disk drive 118 during execution by the processor 102 or GPU 152 of information handling system 100. The main memory 104, GPU 152, and the processor 102 also may include computer-readable media.

Main memory 104 or other memory of the embodiments described herein may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The applications and associated APIs described herein, for example, may be stored in static memory 106 or on the drive unit 118 that may include access to a computer-readable medium 108 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In an embodiment, the information handling system 100 may further include a power management unit (PMU) 120 (a.k.a. a power supply unit (PSU)). The PMU 120 may manage the power provided to the components of the information handling system 100 such as the processor 102, a cooling system, one or more drive units 118, the GPU 152, a video/graphic display device 142 or other input/output devices 140 such as the stylus 146, a mouse 150, a keyboard 144, and a trackpad 148 and other components that may require power when a power button has been actuated by a user. In an embodiment, the PMU 120 may monitor power levels and be electrically coupled, either wired or wirelessly, to the information handling system 100 to provide this power and coupled to bus 116 to provide or receive data or instructions. The PMU 120 may regulate power from a power source such as a battery 122 or A/C power adapter 124. In an embodiment, the battery 122 may be charged via the A/C power adapter 124 and provide power to the components of the information handling system 100 via a wired connections as applicable, or when A/C power from the A/C power adapter 124 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include software, including firmware embedded at a device, such as an Intel® Core class processor, ARM® brand processors, Qualcomm® Snapdragon processors, or other processors and chipsets, or other such device, or software capable of operating a relevant environment of the information handling system. The system, device, controller, or module can also include a combination of the foregoing examples of hardware or software. Note that an information handling system can include an integrated circuit or a board-level product having portions thereof that can also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another can communicate directly or indirectly through one or more intermediaries.

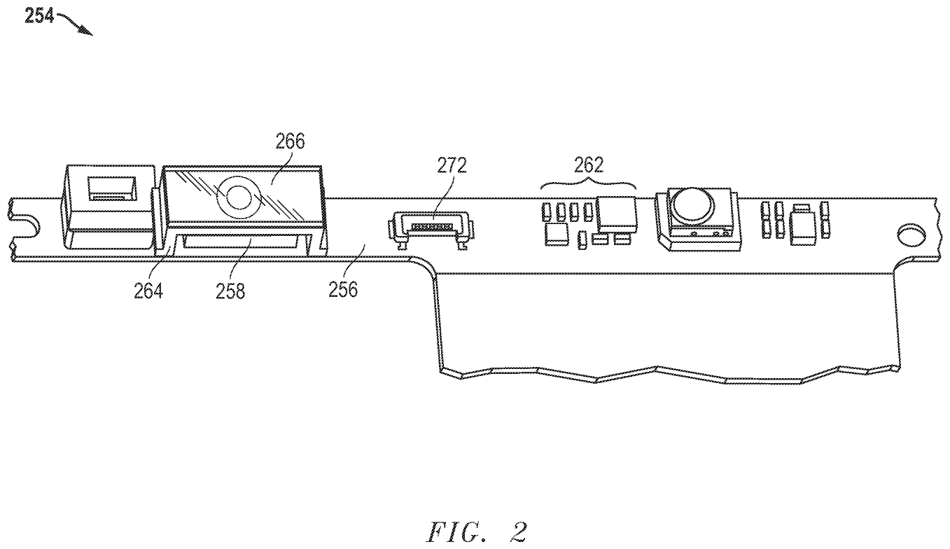

FIG. 2 is a graphic diagram of a camera module 254 with a frame 264 and electrochromic glass shutter 266 over the camera 258 according to an embodiment of the present disclosure. The components of the camera module 254 may be operatively coupled together or to the cable connection 272 via metal traces formed on the PCB 256. As described herein, the camera module 254 may be a modular unit that may be inserted behind a bezel in a display chassis of the information handling system. It is appreciated that some of the components may be formed on other PCBs within other chassis of the information handling system and the camera module 254 shown in FIG. 2 is an example embodiment.

The camera module 254 shown in FIG. 2 includes a cable connection 272 used to operatively couple the components of the camera module 254 to, for example, an embedded controller, a PMU, and/or the processor of the information handling system. In an embodiment, the connection may be a ribbon or flexible cable connection that may transmit data and power signals to the camera module 254 from the circuit switch and power circuit respectively in those embodiments where the power circuit is not formed on the camera module 254.

The camera module 254 may include a power circuit 262. In an embodiment, the power circuit 262 may be operatively coupled to the camera 258 and other components of the camera module 254 and, in an embodiment, to the EC and the PMU of the information handling system via the cable connection 272. In an embodiment, the power circuit 262 may operate independent of the PMU described herein. In another embodiment, the power circuit 262 may form part of or include the PMU. In an embodiment, the power circuit 262 is not formed on the camera module 254 and, instead, is in the base chassis of the information handling system.

As described herein, the camera module 254 includes a camera 258. The camera 258 may be operatively coupled to a cable connection, for example, in order to operatively couple the camera and the other components of the camera module 254 to the processor of the information handling system via a ribbon cable or other wired connection. The camera 258 may be any type of camera such as a webcam used to capture, in some embodiments, an image of the user while the user is engaged in, for example, a videoconferencing session with a remote user. A lens (not shown) may be included with the camera 258 to properly focus the image to the image capture electronics of the camera 258 and change that focus in some embodiments. Any image capture electronics may be used as image sensors and an image capture component in the camera including charge-couple devices, metal oxide semiconductor (MOS) capacitors, CMOS sensors, NMOS active-pixel sensors, MOS dynamic RAM memory chips, PCB, and other circuit components.

In an embodiment, the camera module 254 may include a frame 264. The frame 264 may be made of plastic, metal, or other suitable materials and may be arranged above the camera 258. In an embodiment, the frame 264 may support the electrochromic glass shutter 266 over the camera 258 placing the electrochromic glass shutter 266 at a distance away from the camera 258. The height of the frame 264 may depend on the height of the camera 258 and the distance that the electrochromic glass shutter 266 is to be placed away from the lens of the camera 258. In an embodiment, the frame 264 height may be such to place the electrochromic glass shutter 266 against the lens of the camera 258 to ensure no image capture when the electrochromic glass shutter 266 is turned opaque.

The electrochromic glass shutter 266 may be operatively coupled to the power circuit 262 or other power source to change the opacity or transparency of the electrochromic glass shutter 266 via a circuit switch controlled by an EC in some embodiments. The electrochromic glass shutter 266 is operatively coupled to the power circuit 262 to receive a voltage across one or more layers in order to change the opacity or opacity level of the electrochromic glass shutter 266. In an embodiment, the power circuit 262 may provide a level of voltage sufficient to change the opacity level or transparency level of the electrochromic glass shutter 266. By way of example, the power circuit 262 may provide a first voltage, e.g., +1.2 volts, of electrical charge (e.g., an electrical pulse) across the electrochromic layer of the electrochromic glass shutter 266 to cause the electrochromic glass shutter 266 to switch to an “on” state by, for example turning opaque. In an embodiment, a single electrical pulse of the first voltage, such as +1.2 volts, may be sufficient to change the opacity of the electrochromic glass shutter 266 without maintaining a charge or current across the electrochromic layer of the electrochromic glass shutter 266. This may reduce the amount of power used to change the opacity or translucency of the electrochromic glass shutter 266 by not requiring a constant electrical current to maintain an opaque state at the electrochromic glass shutter 266. Similarly, a single pulse of electrical charge at a second voltage may turn off the electrochromic glass shutter 266 and maintain the electrochromic glass shutter 266 in a transparent state without constant electrical current. It is appreciated that any first voltage may be applied across the electrochromic layer of the electrochromic glass shutter 266 to turn the electrochromic layer of the electrochromic glass shutter 266 to an “on” state that either turns the electrochromic glass shutter 266 opaque or nearly opaque.

It is appreciated that any second voltage may be used to turn the electrochromic glass shutter 266 to an “off” state that is transparent or nearly transparent. For example, an opposite voltage pulse (e.g., negative 1.2-volt electrical pulse) may be applied to make the electrochromic glass shutter 266 transparent or semi-transparent. In an alternative embodiment, a grounding source may be switched to the electrochromic layer of the electrochromic glass shutter 266 to ground the electrochromic layer of the electrochromic glass shutter 266 to make the electrochromic glass shutter 266 transparent or semi-transparent. It is also appreciated that any electrical pulse at any first voltage that is negative, positive or ground may be used to make the electrochromic glass shutter 266 opaque while any second voltage that is positive, negative or ground but different from the first voltage may make the electrochromic glass shutter 266 transparent or semitransparent.

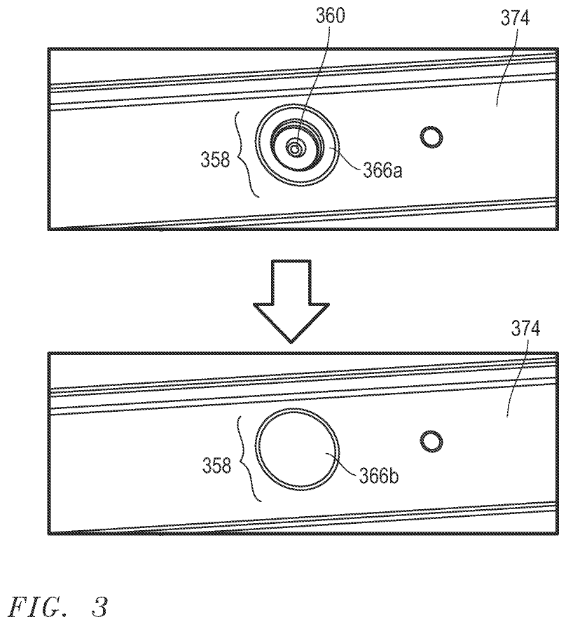

FIG. 3 is a graphic diagram of an electrochromic glass shutter 366a or 366b changing from transparent/translucent to opaque in an embodiment of the present disclosure. As described herein, the b-cover of the display chassis of the information handling system may include a portion of a video display device (not shown) and the present specification contemplates that the camera 358 may be placed behind either a bezel 374 of the b-cover or behind the video display device when a bezel 374 is not present. In an embodiment, the camera 358 may be placed at the top center of the bezel 374. In an embodiment, the camera 358 may be placed at a bottom center of the bezel 374.

In either example embodiment, a hole may be formed through the bezel 374 or the video display device so that the camera 358 can capture an image of the environment in front of the information handling system including the user. In an embodiment, the electrochromic glass shutter 366a, 366b is operatively coupled to the power circuit and circuit switch to receive a voltage in order to change the opacity or opacity level of the electrochromic glass shutter 366a, 366b upon control via an embedded controller (EC). In an embodiment, the power circuit may provide a level of voltage sufficient to change the opacity level or transparency level of the electrochromic glass shutter 366a, 366b. By way of example, the power circuit may provide first voltage, e.g., +1.2 volt, to cause the electrochromic glass layer of the electrochromic glass shutter to turn opaque as shown in FIG. 3 via the transition of a clear electrochromic glass shutter 366a to an opaque electrochromic glass shutter 366b. In an embodiment, a single pulse of first voltage, such as at +1.2 volts, may be sufficient to maintain the opacity of the electrochromic glass shutter 366 without maintaining a continuous electrical current to the electrochromic layer of the electrochromic glass shutter 366. This may reduce the amount of power used to change the opacity or translucency of the electrochromic glass shutter 366a, 366b by not requiring a constant electrical current to maintain a transparent or opaque state at the electrochromic glass shutter 366a, 366b.

It is appreciated that a second voltage, such as an opposite voltage pulse at negative 1.2-volts, may be applied to make the electrochromic glass shutter 366b that is opaque to transition to a transparent or semi-transparent electrochromic glass shutter 366a according to an embodiment of the present specification. In an alternative embodiment, a switch to ground or 0 volts may be applied to make the electrochromic glass shutter 366b transparent or semi-transparent as shown at 366a. It is also appreciated that any negative electrical pulse at any voltage may be used to make the electrochromic glass shutter 366b opaque while a positive voltage electrical pulse or ground may make the electrochromic glass shutter 366a transparent or semitransparent.

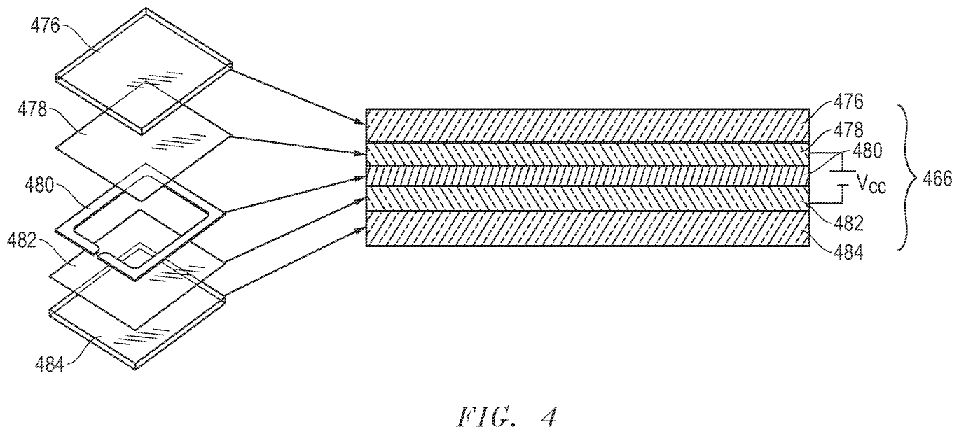

FIG. 4 is a graphic diagram of an electrochromic glass shutter 466 to be formed over a camera according to an embodiment of the present disclosure. The electrochromic glass shutter 466 may include one or more layers depending on the type of electrochromic glass shutter 466 used. For example, an electrochromic layer 480 of the electrochromic glass shutter 466 may include a material coating that includes lithium ions, for example, that migrate back and forth between opposing first conductive layer 478 and second conductive layer 482 of the electrochromic glass shutter 466. This migration to of lithium ions (e.g., from LiCoO₂ coating) to an electrode layer (one of the first conductive layer 478 or second conductive layer 482) may cause the lithium ions to bond with, for example, a WO₃ layer causing them to reflect light. It is appreciated that the LiCoO₂ coating and WO₃ layer are merely examples and other compounds that provide for the migration of these ions may be used in embodiments herein. In other example embodiments, an electrochromic material such as an electrochromic dye may be used that changes color or opacity when a current passes through it. In yet other example embodiments, the electrochromic layer of the electrochromic glass shutter 166 may include nanocrystals that, when a voltage is created across them, change color or opacity.

Some of the layers of the electrochromic glass layer 466 shown in FIG. 4 may be operatively coupled to a power source (e.g., Vcc) used to activate the electrochromic layer 480 via a voltage difference across the first conductive layer 478 and second conductive layer 482. In an embodiment, the first conductive layer 478 may be sandwiched between the electrochromic layer 480 and a first glass outer layer 476. The second conductive layer 482 may be sandwiched between the electrochromic layer 480 and a second glass outer layer 484 in an embodiment.

As described herein, the power circuit with a circuit switch may provide a level of voltage sufficient to change the opacity level or transparency level of the electrochromic glass layer 480 of the electrochromic glass shutter 466. By way of example, the power circuit (e.g., Vcc) may provide a first voltage, such as +1.2 volts, between the first conductive layer 478 and the second conductive layer 482 to cause the electrochromic glass outer layer 480 to turn opaque. In an embodiment, a single pulse voltage at a first voltage, such as +1.2 volts, may be sufficient to maintain the opacity of the electrochromic glass shutter 466 without maintaining an electrical current. This may reduce the amount of power used to change the opacity or translucency of the electrochromic glass shutter 466 by not requiring a constant electrical current or voltage to maintain a transparent or opaque state at the electrochromic glass shutter 466.

It is appreciated that a second voltage that is a different voltage from the first voltage, such as an opposite voltage pulse (e.g., negative 1.2-volt electrical pulse), may be applied between the first conductive layer 478 and the second conductive layer 482 to make the electrochromic glass layer 480 transparent or semi-transparent. In an alternative embodiment, a grounding between the first conductive layer 478 and the second conductive layer 482 or any second voltage may be applied to make the electrochromic glass layer 480 transparent or semi-transparent. It is also appreciated that any negative electrical pulse at any first voltage or ground between the first conductive layer 478 and the second conductive layer 482 may be used to make the electrochromic glass layer 480 opaque while a positive second voltage electrical pulse or grounding between the first conductive layer 478 and the second conductive layer 482 may make the electrochromic glass layer 480 transparent or semitransparent. It is appreciated that any first voltage between the first conductive layer 478 and the second conductive layer 482 may be used to change the opacity or transparency of the electrochromic glass layer 480. It is further appreciated that any second voltage between the first conductive layer 478 and the second conductive layer 482 may be used to change the electrochromic glass layer 480 back to being either opaque or transparency.

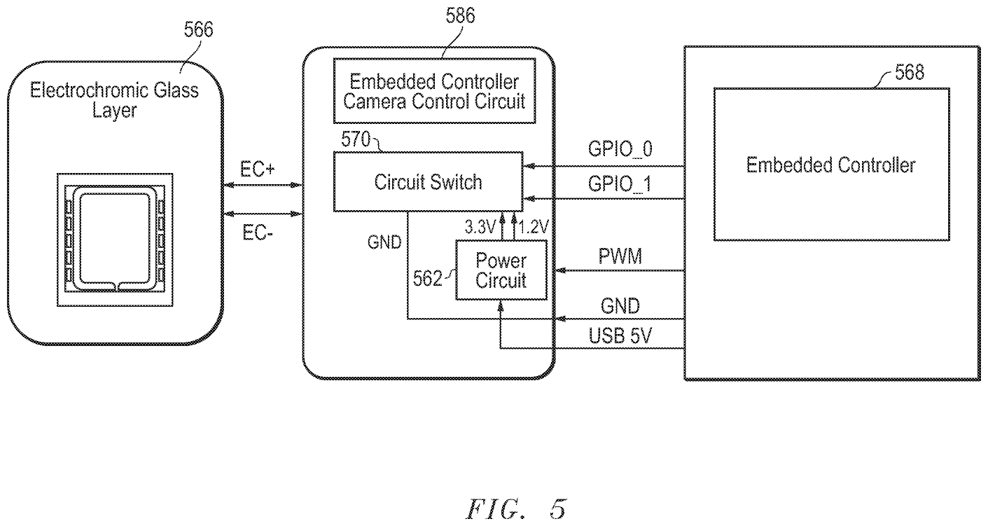

FIG. 5 is a block diagram of an embedded controller camera control circuit 586 according to an embodiment of the present disclosure. As described herein, the camera module may be operatively coupled to an embedded controller (EC) 568 that executes a circuit switch 570 used to direct the power circuit 562 to apply an electrical charge to the electrochromic glass shutter 566 across an electrochromic layer on two conductive layers on the camera module. As described herein, the power circuit 562 may be placed on the camera module similar to that shown in FIG. 2. FIG. 5 shows the power circuit 562 operatively coupled to the circuit switch 570 and EC 568 but may be physically apart from the embedded controller camera control circuit 586 in some embodiments.

The EC 568 may, in an example embodiment, may operate below the OS and BIOS of the information handling system. By operating below the OS and BIOS, the EC 568 may operate independent of other processors such as the processor and the GPU of the information handling system. This prevents the EC 568 from being accessed via a security breach. Further, this prevents the operation of the camera module and electrochromic glass shutter 566 to be handled by the processor thereby preventing valuable processing resources from being consumed in changing the opacity or transparency levels of the electrochromic glass shutter 566. In an embodiment, the EC 568 executes firmware to send a command to the circuit switch 570 to switch to a voltage that will close the electrochromic glass shutter 566 (e.g., turn it “on” or make it opaque) or open the electrochromic glass shutter 566 (e.g., turn it “off” or make it transparent).

In an embodiment, the EC 568 may be operatively coupled to a circuit switch 570. FIG. 5 shows the circuit switch 570 at the embedded controller camera control circuit 586. However, it is appreciated that the EC 568 and circuit switch 570 may both be operatively coupled to, for example, a motherboard or other PCB of the information handling system in an embodiment. The circuit switch 570 may be any type of switch that controls the power circuit 562 by receiving input to change the opacity or translucency of the electrochromic glass shutter 566 from the EC 568 and directing the power circuit 562 to provide an electrical signal at a voltage to the electrochromic glass shutter 566 according to various embodiments. In an embodiment, the EC 568 may trigger the circuit switch 570 to cause the electrical signal and appropriate voltage to be sent to the electrochromic glass shutter 566 accordingly. In an embodiment, the circuit switch 570 may be a TI switch TS3A24159 manufactured by Texas Instruments®. The present specification contemplates that any type of switch or similar switch may be used to control the power circuit 562 on the camera module.

In an embodiment, the EC 568 may receive input via a hot-key or other key on the keyboard 544 of the information handling system. For example, a user may actuate a key or series of keys on the keyboard as input to the EC 568 to access the circuit switch 570 as described herein. In an embodiment, the key may be a function key such as an F9 key. In another embodiment, the user may access a settings menu via a GUI or use a soft key to cause the signal to be sent to the EC 568 to conduct the change in opacity or transparency at the electrochromic glass shutter 566 and close the electrochromic glass shutter 566.

The general input/output signal sent by the EC 568 to the circuit switch 570 may indicate whether the electrochromic glass shutter 566 is to be made transparent (e.g., GPIO_0) or opaque (e.g., GPIO_1). An electrical current (e.g., EC+ or EC−) may be sent to the electrochromic glass shutter 566 when the circuit switch 570 of the embedded controller camera control circuit 586 has sent the signal to provide the appropriate voltage and electrical current to the circuit switch 570. In an embodiment, the circuit switch 570 may include a pair of single pole, double throw switches that control the logic to determine whether and what voltages to direct to the conductive layers of the electrochromic glass shutter 566.

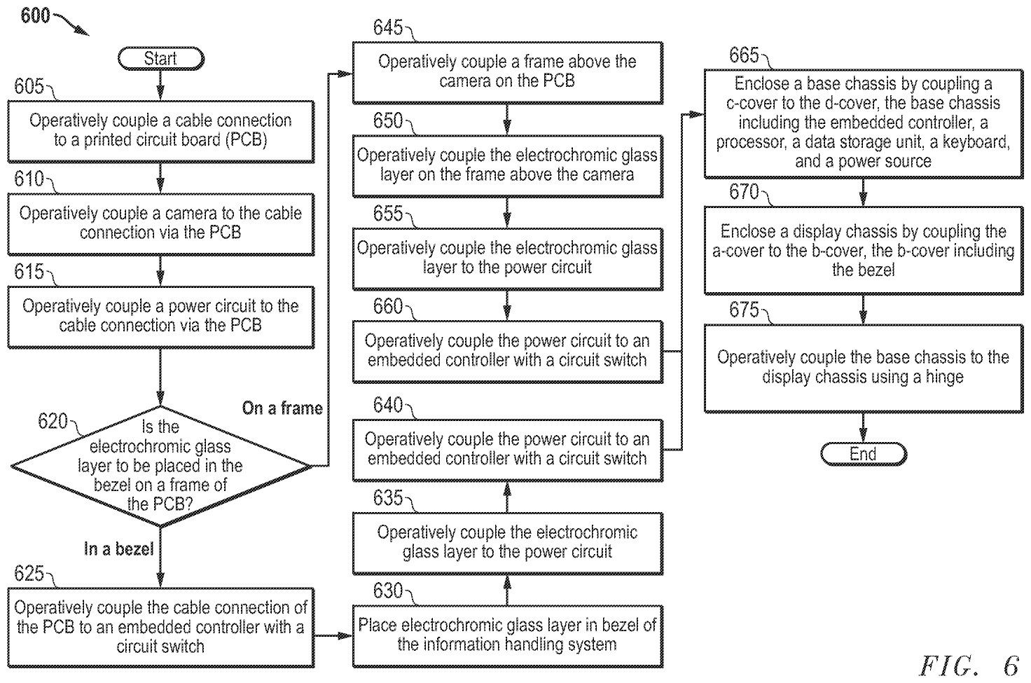

FIG. 6 is a flow diagram of a method 600 of manufacturing an information handling system with a camera and an electrochromic glass shutter formed over the camera according to an embodiment of the present disclosure.

The method 600 includes, at block 605, with operatively coupling a cable connection to a PCB. The cable connection, in an embodiment, may operatively couple the PCB forming the camera module to both data and power sources. For example, the cable connection may operatively couple the camera module to the processor or embedded controller described herein. Further, the cable connection may operatively couple to the camera module to the power circuit or PMU as described herein. The communication cable may be used to transfer image data to the processor in an embodiment.

In an embodiment, the cable connection may be used to operatively couple the components of the camera module to the processing, data storage, and power resources in the information handling system. The method 600 may further include, at block 610, with operatively coupling a camera to the cable connection via the metal trances formed on the PCB. The camera may be any type of camera such as a webcam used to capture, in some embodiments, an image of the user while the user is engaged in, for example, a videoconferencing session with a remote user. A lens may be included with the camera to properly focus the image in the frame of the camera and change that focus in some embodiments. Any image capture electronics may be used as an image capture component to form the camera including charge-couple devices, MOS capacitors, CMOS sensors, NMOS active-pixel sensors, MOS dynamic RAM memory chips, PCB, and other circuit components.

The method 600 may further include operatively coupling a power circuit to the cable connection via the metal traces formed on the PCB at block 615. In an embodiment, the power circuit may also be operatively coupled to the camera to provide power to the camera. Alternatively, the camera may be provided power via the cable connection from the PMU. In an embodiment, the power circuit may operate independent of the PMU described herein. In another embodiment, the power circuit may form part of or include the PMU. In one embodiment, the power circuit is not formed on the camera module and, instead, is in the base chassis of the information handling system.

The method 600 may continue with a determination as to whether the electrochromic glass shutter is to be placed in a bezel or on a frame formed on the PCB at block 620. As described herein, the electrochromic glass layer may be either placed into a hole or viewing port formed in the bezel or video display device of the information handling system or may be placed on a frame that has been operatively coupled to the PCB and over the camera inside the display chassis. Where the design of the information handling system dictates that the electrochromic glass layer is to be placed within a hole or port formed in the bezel of the b-cover, the method 600 continues from block 620 to block 625 with operatively coupling the electrochromic glass shutter with the cable connection of the PCB to an embedded controller with a circuit switch in the information handling system. For example, the EC and circuit switch may be in a base chassis of the information handling system. The electrochromic glass layer is then placed with the hole or port formed in the bezel or video display device at block 630 and secured therein via a fastener, an adhesive, or any other securing device.

At block 635 the method 600 includes operatively coupling the electrochromic glass shutter to the power circuit. As described herein, the power circuit is directed by the circuit switch to provide an electrical voltage or pulse to the conductive layers around the electrochromic glass layer of the electrochromic glass shutter at a specific voltage. The electrochromic glass shutter may, therefor, include one or more electrical lines from the conductive layers of the electrochromic glass shutter on either side of an electrochromic glass layer to the power circuit to allow the electrochromic glass layer to be changed from transparent to opaque or back again via application of those electrical currents or pulses for an “on” voltage or first voltage or an “off” voltage or second voltage different from the first voltage for the electrochromic glass shutter.

At block 640, the method 600 includes operatively coupling the power circuit to an embedded controller with a circuit switch. This may be done via the cable connection using, for example, a ribbon cable. As described herein, the camera module may be operatively coupled to an embedded controller that triggers a circuit switch used to direct the power circuit to apply a first electrical voltage to the electrochromic glass shutter on the camera module to turn “on” or make opaque the electrochromic glass shutter and a second electrical voltage to turn “off” or make transparent the electrochromic glass shutter. The power circuit may be placed on the camera module similar to that shown in FIG. 2. The power circuit may be operatively coupled to the circuit switch and embedded controller but may physically not form part of the embedded controller camera control circuit in some embodiments.

Where the design of the information handling system dictates that the electrochromic glass shutter is to be placed on a frame of the PCB, the method 600 continues from block 620 to block 645 with operatively coupling the frame above the camera formed on the PCB. In an embodiment, the frame may be made of plastic, metal, or any other suitable material. The frame may support the electrochromic glass shutter over the camera placing the electrochromic glass shutter at a distance away from the camera. The height of the frame may depend on the height of the camera and the distance that the electrochromic glass shutter is to be placed away from the lens of the camera. In an embodiment, the frame height may place the electrochromic glass shutter against the lens of the camera.

The method 600 may continue with operatively coupling the electrochromic glass shutter onto the frame above the camera at block 655. In an embodiment, the frame may include an adhesive, fasteners, or other securing devices to hold the electrochromic glass shutter in place during operation of the camera.

The method 600 may further include, at block 660, operatively coupling the conductive layers around the electrochromic glass layer of the electrochromic glass shutter to the power circuit. Again, the power circuit may provide power, as directed by the circuit switch and the embedded controller in order to change the opacity or translucency of the electrochromic glass shutter. Again, this may be done via the cable connection using, for example, a ribbon cable. As described herein, the camera module may be operatively coupled to an embedded controller that triggers a circuit switch used to direct the power circuit to apply an electrical charge across the electrochromic glass layer of the electrochromic glass shutter on the camera module. The power circuit may be placed on the camera module similar to that shown in FIG. 2 in one embodiment. The power circuit may be operatively coupled to the circuit switch and embedded controller but may physically not form part of the embedded controller camera control circuit in other embodiments.

At this point, the method 600 may continue with enclosing a base chassis by coupling a c-cover to the d-cover at block 665 after assembling components of the information handling system therein. In an embodiment, the base chassis includes the embedded controller, a processor, a data storage unit, a keyboard, and a power source such as a battery or A/C adapter among other hardware devices. Any of the several components of FIG. 1 may be installed in the base chassis, or in the display chassis. This base chassis may, during operation of the information handling system, rest on a user's lap or on a table.

The method 600 also includes, at block 670, enclosing a display device in a display chassis by coupling the a-cover to the b-cover, the b-cover including the bezel in an embodiment. As described herein, the b-cover may include a bezel outlining a video display device of the information handling system. The camera, such as a webcam, may be disposed inside the bezel at a port/hole formed in the webcam in the bezel. However, where no bezel is present, the video display device is secured to the a-cover of the display chassis with the camera module placed between the video display device and the a-cover at a window of the display device for a webcam. Again, where no bezel is present, the video display device may include a hole, port, or window behind which the camera may be placed to receive images.

The method 600 further includes operatively coupling the base chassis to the display chassis using a hinge at block 675. In an embodiment, the hinge may allow the display chassis to rotate 360 degrees relative to the base chassis. Once assembled, the method 600 may end.

The blocks of the flow diagrams of FIG. 6 or steps and aspects of the operation of the embodiments herein and discussed above need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system comprising:
a processor;
a memory device;
a power management unit (PMU);
a camera formed into a chassis of the information handling system, the camera including:
a lens and an electronic image capture component;
an electrochromic glass shutter formed over the lens, the electrochromic glass shutter operatively coupled to a circuit switch to receive a voltage to change the opacity of the electrochromic glass shutter, the circuit switch operatively coupled to and controlled by an embedded controller (EC).

2. The information handling system of claim 1 further comprising:
the embedded controller operating below a basic input/output system (BIOS) executed by the processor of the information handling system; and
the EC to receive a user input to turn on or turn off the electrochromic glass shutter.

3. The information handling system of claim 1 further comprising:
the PMU operatively coupled to the circuit switch to control a first voltage provided across an electrochromic glass layer of the electrochromic glass shutter to make the electrochromic glass layer opaque.

4. The information handling system of claim 1 further comprising:
a dedicated button used by a user to change the opacity of the electrochromic glass shutter, the dedicated button including a hot-key on a keyboard of the information handling system communicatively coupled to the EC.

5. The information handling system of claim 1, wherein the electrochromic glass shutter is formed into a bezel of the information handling system over the camera to block image capture by the camera when the electrochromic glass shutter is opaque.

6. The information handling system of claim 1 further comprising:
a printed circuit board (PCB) onto which the camera is installed, the PCB including a frame formed over the camera to hold the electrochromic glass layer over the camera to block image capture by the camera when the electrochromic glass shutter is opaque.

7. The information handling system of claim 1 further comprising:
a printed circuit board (PCB) onto which the camera is installed, the PCB including the circuit switch to receive input from the embedded controller to change the opacity of the electrochromic glass shutter, the circuit switch operatively coupled to the electrochromic glass shutter to send the voltage level to select the opacity of the electrochromic glass shutter.

8. The information handling system of claim 1 further comprising:
the electrochromic glass shutter including:
an electrochromic glass layer;
a first conductive layer formed on a first side of the electrochromic glass layer;
a second conductive layer formed on a second side of the electrochromic glass layer;
a first glass outer layer formed on the first conductive layer; and
a second glass outer layer formed on the second conductive layer.

10. A camera module formed into a bezel of an information handling system comprising:
a lens and an electronic image capture component;
an electrochromic glass shutter formed into the bezel and placed over the lens, wherein the electrochromic glass shutter is operatively coupled to a power management unit (PMU) of the information handling system; and
a circuit switch to send a voltage used to change the opacity of the electrochromic glass shutter, the circuit switch operatively coupled to and controlled by an embedded controller (EC).

11. The camera module of claim 10 further comprising:
the embedded controller to receive a user input from a software setting to change the opacity of the electrochromic glass shutter.

12. The camera module of claim 10 further comprising:
the PMU operatively coupled to the embedded controller to control the voltage to the electrochromic glass shutter via the circuit switch independent of the operations of the processor of the information handling system.

13. The camera module of claim 10 further comprising:
a dedicated switch used by a user to change the opacity of the electrochromic glass layer, the dedicated switch including a hot-key on a keyboard of the information handling system operatively coupled to the EC.

14. The camera module of claim 10 further comprising:
the voltage used to change the opacity of the electrochromic glass shutter includes:
a first voltage from the circuit switch to turn the electrochromic glass shutter on and make the electrochromic glass shutter opaque; and
a second voltage from the circuit switch to turn the electrochromic glass shutter off and make the electrochromic glass shutter transparent.

15. The camera module of claim 10 further comprising:
a printed circuit board (PCB) onto which the camera is installed, the PCB including a frame formed over the camera to hold the electrochromic glass layer over the camera to block image collection by the camera for privacy where the electrochromic glass shutter is opaque.

16. The camera module of claim 10 further comprising:
the electrochromic glass shutter including:
an electrochromic glass layer;
a first conductive layer formed on a first side of the electrochromic glass layer;
a second conductive layer formed on a second side of the electrochromic glass layer;
a first glass outer layer formed on the first conductive layer; and
a second glass outer layer formed on the second conductive layer.

17. A camera module of an information handling system comprising:
a printed circuit board (PCB);
a camera;
a power circuit formed on the PCB and operatively coupled to the camera;
a frame formed over the camera; and
an electrochromic glass shutter having voltage-controlled opacity disposed on the frame and over the camera to block image capture by the camera when the electrochromic glass shutter is made opaque,
wherein the camera module is formed in a bezel of the information handling system.

18. The camera module of claim 17 further comprising:
a cable connection operatively coupling the camera and electrochromic glass layer to an embedded controller (EC) operating below a basic input/output system (BIOS) executed by the processor of the information handling system.

19. The of claim 18 further comprising:
the PMU operatively coupled to the EC and the PCB, the EC to control the voltage to the electrochromic glass shutter via a circuit switch.

20. The of claim 18 further comprising:
a circuit switch operatively coupled to the electrochromic glass shutter with a first voltage sent to the electrochromic glass shutter to turn it opaque and a second voltage sent to the electrochromic glass shutter to make it transparent, the circuit switch to receive input from the EC to change the opacity of the electrochromic glass shutter.
